(19) United States
(12) Patent Application Publication
(10) Pub. No.: US 2025/0237737 A1
(43) Pub. Date: Jul. 24, 2025

(54) SEMICONDUCTOR DEVICE, METHOD FOR CONTROLLING THE SEMICONDUCTOR DEVICE, AND PROGRAM

(71) Applicant: Renesas Electronics Corporation, Tokyo (JP)

(72) Inventors: Keisuke MATSUDA, Tokyo (JP); Noriko YOSHIMOTO, Tokyo (JP)

(21) Appl. No.: 18/967,962

(22) Filed: Dec. 4, 2024

(30) Foreign Application Priority Data
Jan. 24, 2024 (JP) 2024-008681

(51) Int. Cl. G01S 7/03; G01S 7/35; G01S 13/66

(52) U.S. Cl. CPC G01S 7/03; G01S 7/356; G01S 13/66

(57) ABSTRACT

A Semiconductor device capable of performing efficient signal processing, to provide a control method and a program of the semiconductor device. The semiconductor device includes a first signal processing unit, a second signal processing unit, and a control unit. The control unit includes: a detection unit that detects the process amount of the second process in which the first signal processing unit or the second signal processing unit executes; a prediction unit that predicts the process amount of the second process to be executed next based on the process amount of the detected second process; and a distribution unit that distributes the first process to the first signal processing unit and the second signal processing unit according to the process amount of the predicted second process.

### CROSS-REFERENCE TO RELATED APPLICATIONS

The disclosure of Japanese Patent Application No. 2024-008681 filed on Jan. 24, 2024, including the specification, drawings and abstract is incorporated herein by reference in its entirety.

### BACKGROUND

The present invention relates to a semiconductor device, a control method and a program of the semiconductor device.

These are disclosed techniques listed below. [Non-Patent Document 1] Marcio L. Lima de Oliveira, Marco J. G. Bekooij, “Deep Convolutional Autoencoder Applied for Noise Reduction in Range-Doppler Maps of FMCW Radars”, 2020 IEEE International Radar Conference (RADAR), 2020, p.630-635

For example, as a technique related to signal processing of the radar device, Non-Patent Document 1 is known. Non-Patent Document 1 describes a way to process the received signal based on the reflected wave received by FMCW (Frequency Modulated Continuous Wave) radar.

### SUMMARY

Non-Patent Document 1 describes that a signal process such as FFT (Fast Fourier Transform) processing or CFAR (Constant False Alarm Rate)/peak detection process is performed on a received signal of a radar device. It is desired to perform such signal process efficiently.

Other objects and novel features will become apparent from the description of this specification and the accompanying drawings.

According to an embodiment, a semiconductor device includes a first signal processing unit, a second signal processing unit, and a control unit. The first signal processing unit and the second signal processing unit is capable of performing a first process and a second process performed based on the result of the first process. The control unit includes a detection unit, a prediction unit, and a distribution unit. The detection unit detects the process amount of the second process that the first signal processing unit or the second signal processing unit executes. The prediction unit predicts the process amount of the second process to be executed next based on the process amount of the detected second process. The distribution unit distributes the first process to the first signal processing unit and the second signal processing unit according to the process amount of the predicted second process.

### BRIEF DESCRIPTION OF THE DRAWINGS

FIG. 1 is a block diagram showing a configuration example of a related radar signal processing system.

FIG. 2A is a diagram showing an example of a related distribution method.

FIG. 2B is a diagram showing an example of a related distribution method.

FIG. 3 is a configuration diagram showing an outline configuration of a semiconductor device according to an embodiment.

FIG. 4A is a diagram showing an example of a distribution method in the semiconductor device according to the embodiment.

FIG. 4B is a diagram showing an example of a distribution method in the semiconductor device according to the embodiment.

FIG. 5 is a configuration diagram showing a configuration example of hardware of the semiconductor device according to a first embodiment.

FIG. 6 is a configuration diagram showing a configuration example of a functional block of the semiconductor device according to the first embodiment.

FIG. 7 is a flowchart showing an operation example of the semiconductor device according to the first embodiment.

FIG. 8 is a graph showing an example of a weight coefficient determination table according to the first embodiment.

FIG. 9 is a graph showing an example of the number of detected peaks for each frame according to the first embodiment.

FIG. 10 is a graph showing an example of DSP distribution rate determination table according to the first embodiment.

FIG. 11 is a configuration diagram showing an example of a functional block of the semiconductor device according to a modification of the first embodiment.

FIG. 12 is a graph showing an example of DSP process times for each frame according to a modification of the first embodiment.

FIG. 13 is a graph showing an example of a DSP distribution rate determination table according to a modification of the first embodiment.

FIG. 14 is a configuration diagram showing a configuration example of a functional block of the semiconductor device according to a second embodiment.

FIG. 15 is a diagram showing an example of the object disappearance according to the second embodiment.

FIG. 16 is a graph showing an example of the number of detected peaks for each frame according to the second embodiment.

FIG. 17 is a configuration diagram showing a configuration example of a functional block of the semiconductor device according to a third embodiment.

FIG. 18 is a graph showing an example of the number of detected peaks for each frame according to the third embodiment.

FIG. 19 is a graph showing an example of DSP distribution rate determination table according to the third embodiment.

### DETAILED DESCRIPTION

Hereinafter, an embodiment will be described with reference to the drawings. For clarity of explanation, the following description and drawings are appropriately omitted and simplified. Further, in the drawings, the same elements are denoted by the same reference numerals, and redundant description is omitted if necessary.

### Investigation of Related Technologies

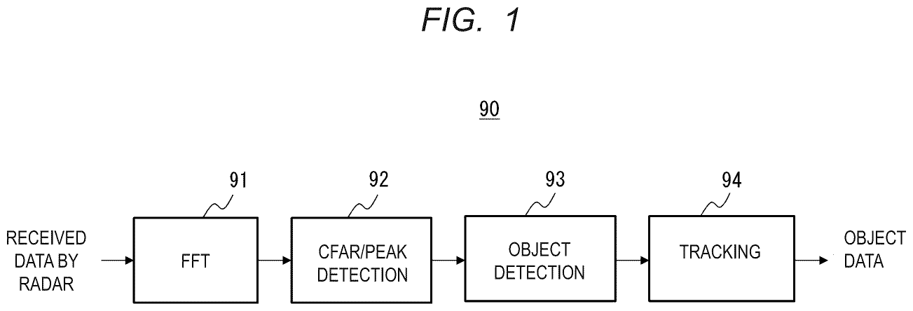

FIG. 1 illustrates a configuration example of a radar signal processing system 90 in related technologies. The radar signal processing system 90 is a system for processing received signal based on the reflected wave received by the radar device.

For example, the radar signal processing system 90 has the same configuration as the functional block described in Non-Patent Document 1. As shown in FIG. 1, the radar signal processing system 90 includes an FFT unit 91, a CFAR/peak detection unit 92, an object detection unit 93, and a tracking unit 94.

The FFT unit 91 performs a FFT process on the radar signal received by the radar device. The radar device transmits the transmitted wave and receives the reflected wave reflected by the object. The radar device AD (Analog to Digital) converts the signal of the received reflected wave and generates radar received data. In the FFT process, a Range-Doppler (RD) map is generated by performing Fourier transforms in the Range and Doppler directions for radar received data. In the RD map, the received signal-level is associated with a two-dimensional map of the range and the Doppler velocity between the radar device and the object.

The CFAR/peak detection unit 92 performs CFAR/peak detection process on the RD map generated by the FFT unit 91. In CFAR/peak detection process, a CFAR process is used to detect the peak (peak point) of the signal level in the RD map. The CFAR process is a signal process that suppresses reflected waves (noises) other than the target and makes the target easy to distinguish.

The part of the peaks detected by the CFAR/peak detection process are expressed as points on the plane. The collection (point cloud) of these points is estimated to be an object. The object detection unit 93 performs object detection process on the point cloud based on the peak (peak point) detected by CFAR/peak detection process. In the object detection process, point clouds are grouped (clustered) and objects are detected. By performing object detection, it is possible to know the position, moving direction, and moving speed of the object.

The tracking unit 94 performs tracking process on the basis of the object detected by the object detection process. In the tracking process, the movement of the detected object is tracked in the frame of the time series. The frame is a unit of data that is detected every measurement period (scan) of the radar device. For each frame, FFT process, CFAR/peak detection process, and the object detection process are performed, and the tracking process is performed for the object detection results of a plurality of frames.

The inventors have studied a method of mounting each process shown in FIG. 1 in a semiconductor device. Since the load to perform the process of FIG. 1 by only CPU (Central Processing Unit) is high, it is possible to reduce the load of CPU by causing the process to be performed in DSP (Digital Signal Processor) mounted on SoC (System on Chip). In such cases, it is necessary to consider how DSP/CPU should share the different processes.

The inventors have found that the signal process of the received signal of the radar apparatus of FIG. 1 can be classified into the following three types of process.
(1) Process A: Process has a constant throughput regardless of the received signal and can be divided into a plurality of DSPs. For example, FFT process for performing speed sensing corresponds to the process A.
(2) Process B: Process amount is fluctuating by the received signal, and cannot be divided depending on the processing of the previous stage (process A). For example, CFAR/peak detection process depending on the previous process A (FFT process) corresponds to the process B.
(3) Process C: Process is independent of other process (process A or process B) of the pre-stage. For example, object detection pre-process or the like corresponds to the process C. Object detection preprocess is the processing required before object detection process.

In signal process, it is common practice to use DSP to reduce CPU loads. For example, as a method of distributing the process to a plurality of DSPs, process that can be divided, such as process A, is distributed evenly, and process that cannot be divided, such as processes B and C, is distributed by using round robin or the like.

The inventors have studied problems when the above-described processes A to C are distributed to a plurality of DSPs using such related distribution methods. For example, it is executed by distributing the process A to a plurality of DSPS, when executing the process B after the process A, the process time of the process B, free time may occur in DSP.

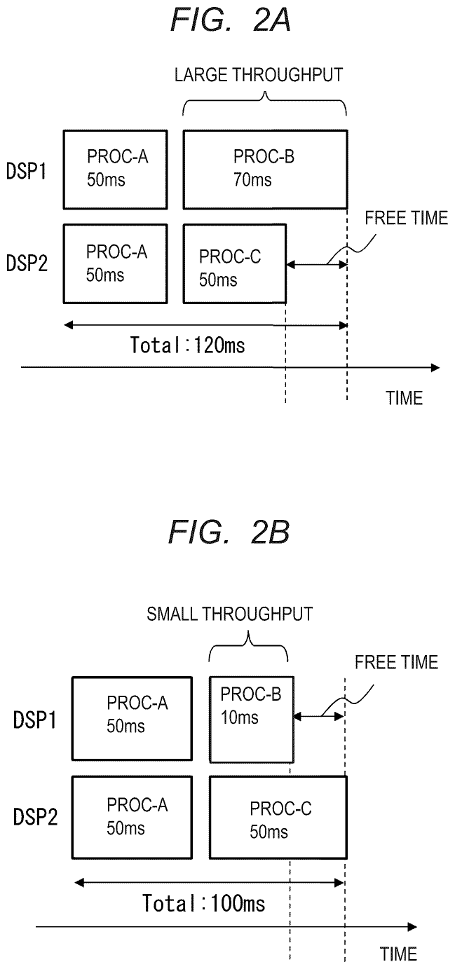

FIGS. 2A and 2B show the cases when the processes A to C are distributed to the DSP1 and the DSP2 by using the related distribution methods. In FIGS. 2A and 2B, process A (PROC-A) is distributed to the DSP1 and the DSP2 evenly, and process B (PROC-B) is distributed to the DSP1, and process C (PROC-C) is distributed to the DSP2.

FIG. 2A shows an example in which the process amount (process time) of process B is larger than that of process C. As shown in FIG. 2A, when the throughput of process B is large, free time occurs in the DSP2. In this instance, the total process time is determined by the process time of the DSP1, and becomes 120 ms due to 50 ms of the process A and 70 ms of the process B.

FIG. 2B shows an example when the throughput of the process B is smaller than that of process C. As shown in FIG. 2B, when the throughput of process B is small, free time occurs in the DSP1. In this instance, the total process time is determined by the process time of the DSP2, and becomes 100 ms due to 50 ms of the process A and 50 ms of the process C.

Thus, when distributing the process by using the related distribution methods, the process amount is biased by DSP, there is a problem that the entire process time is determined by DSP that the most process time. In order to solve this problem, it is conceivable to change the ratio of distributing the process A for each DSP, since the treatment quantity of the process B is not known without performing the process A, it cannot be distributed in advance.

### Summary of the Embodiment

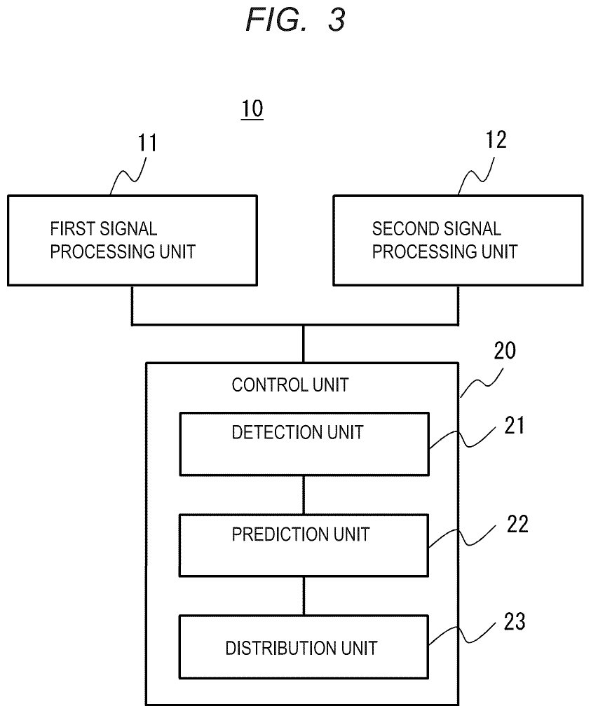

FIG. 3 shows a schematic configuration of a semiconductor device 10 according to the embodiment. For example, the semiconductor device 10 is a semiconductor device that processes the received signal of the radar device, but may be a semiconductor device that processes other signals. As shown in FIG. 3, the semiconductor device 10 includes a first signal processing unit 11, a second signal processing unit 12 and a control unit 20.

Each of the first signal processing unit 11 and the second signal processing unit 12 executes a predetermined process on the input signal. For example, each of the first signal processing unit 11 and the second signal processing unit 12 may be constituted by a DSP. The first signal processing unit 11 and the second signal processing unit 12 execute a first process, and execute a second process to be performed on the basis of the result of the first process. The first process is the above process A such as a FFT process for example. The second process is the above process B such as a CFAR/peak detection process for example. The first signal processing unit 11 and the second signal processing unit 12 may further execute a third process. The third process is the above process C such as an object detection pre-process for example.

The control unit 20 controls the process executed by the first signal processing unit 11 and the second signal processing unit 12. For example, the control unit 20 may be constituted by a CPU (and program). The control unit 20 includes a detection unit 21, a prediction unit 22, and a distribution unit 23.

The detection unit 21 detects the process amount of the second process executed by the first signal processing unit 11 or the second signal processing unit 12. For example, the second process is distributed to the first signal processing unit 11 or the second signal processing unit 12, the distributed signal processing unit executes the second process. The detection unit 21 may detect the process time of the executed second process as the process amount of the second process, or may detect the number of peaks (peak points) detected by CFAR/peak detection process which is the second process.

The prediction unit 22 predicts the process amount of the second process to be performed next based on the process amount of the second process detected by the detection unit 21. For example, a storage unit for storing the process amount of the detected second process, the prediction unit 22, based on the process amount of the second process amount and the second process amount stored in the past detected, the process amount of the second process to be executed next it may be predicted. For example, the prediction unit 22 may predict the process time of the second process to be performed next, or may predict the number of peaks to be detected next.

The distribution unit 23 distributes the first process to be performed next to the first signal processing unit 11 and the second signal processing unit 12 according to the second process amount predicted by the prediction unit 22. The distribution unit 23 determines the process amount of the first process to be distributed to the first signal processing unit 11 and the process amount of the first process to be distributed to the second signal processing unit 12 according to the predicted second process amount. For example, the distribution unit 23 may determine the distribution ratio (ratio of the process amount to be distributed) for the first signal processing unit 11 and the second signal processing unit 12 according to the predicted process amount of the second process and distribute the first process to the first signal processing unit 11 and the second signal processing unit 12 based on the determined distribution ratio.

In the above-described embodiment, when the signal processing unit, which is a DSP or the like, executes the second process following the first process, the first process to be executed is distributed to the signal processing unit based on the process amount of the second process performed. The process amount of the second process to be executed next is predicted from the process amount of the second process performed, by distributing the first process according to the prediction result, the process efficiency of the signal processing unit is improved, it is possible to shorten the process time.

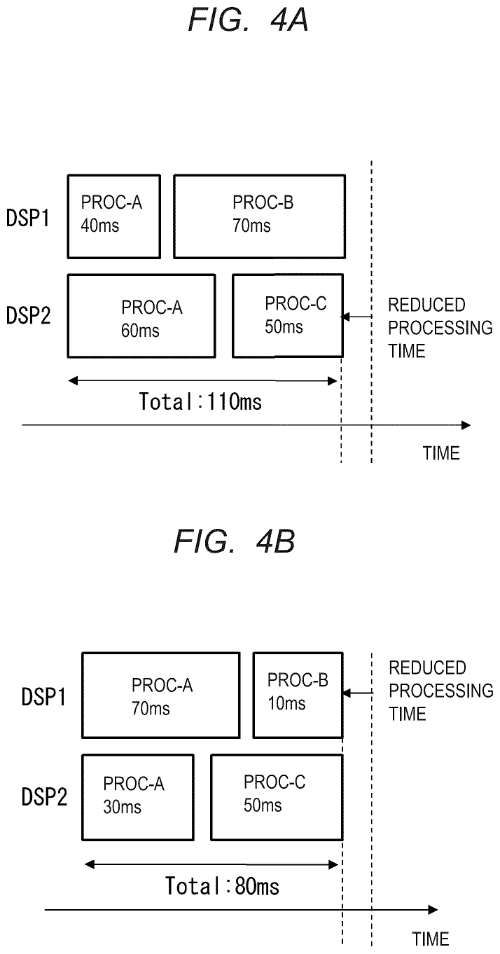

FIGS. 4A and 4B show the cases where the processes A to C are distributed to the DSP1 and the DSP2 by using the distribution methods of the semiconductor devices according to the embodiments. FIG. 4A is an example in which the embodiment is applied to FIG. 2A. Similarly to FIG. 2A, the process amount (process time) of process B is larger than the process amount of process C. In the example of FIG. 4A, the semiconductor device according to the embodiment detects that the process amount of the process B is large, and predicts that the process amount of the following process B increases. For this reason, for process A, the process amount distributed to the DSP1 is reduced from 50 ms to 40 ms, and the process amount distributed to the DSP2 is increased from 50 m to 60 ms. Thus, the free time of DSP2 is eliminated, since the entire process time by DSP1 and DSP2 is 110 ms, as compared with FIG. 2A, it is possible to shorten the entire process time.

FIG. 4B is an example in which the embodiment is applied to FIG. 2B. Similarly to FIG. 2B, the throughput of process B is smaller than that of process C. In the example of FIG. 4B, the semiconductor device according to the embodiment detects that the process amount of the process B is small, and predicts that the process amount of the subsequent process B is reduced. For this reason, for process A, the process amount distributed to the DSP1 is increased from 50 ms to 70 ms, and the process amount distributed to the DSP2 is reduced from 50 ms to 30 ms. Thus, the free time of the DSP1 is eliminated, since the entire process time by the DSP1 and the DSP2 is 80 ms, as compared with 2B shown, it is possible to shorten the total process time.

### First Embodiment

Next, a first embodiment will be described. In the first embodiment, based on the number of peaks detected by CFAR/peak detection process, illustrating an example of DSP distribution process DSP.

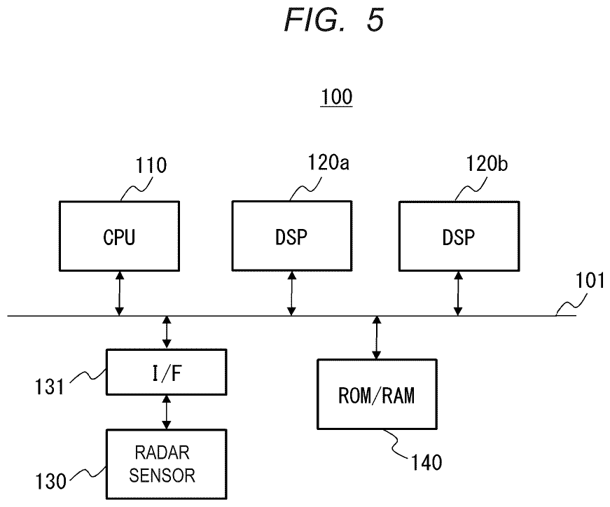

FIG. 5 shows a configuration example of hardware of the semiconductor device 100 according to the first embodiment. The semiconductor device 100 is a semiconductor device that processes the received signal of the radar. For example, the semiconductor device 100 is made of an SoC equipped with a plurality of DSP. For example, the radar applied to the semiconductor device 100 is a vehicle-mounted radar, but may be other radars.

As shown in FIG. 5, the semiconductor device 100 includes a CPU 110, two DSPs 120 (120a and 120b), a radar sensor 130, and a ROM (Read Only Memory)/RAM (Random Access Memory) 140 hardware configurations. The CPU 110, the DSPs 120a and 120b and the ROM/RAM 140 are connected to a bus 101. The radar sensor 130 is connected to the bus 101 via I/F (Interface) 131.

The ROM/RAM 140 stores the data and programs necessary for the operation of the semiconductor device 100, the result of each process, and the like. The ROM/RAM 140 is an example of storage unit for storing data, etc. and may include either ROM and RAM, or both, or may include other types of storage devices.

The radar sensor 130 is a radar device that detects an object by radio waves. The radar sensor 130 may be an FMCW radar, or it may be another type of radar. For example, the radar sensor 130 includes a transmitting antenna and a plurality of receiving antennas. The transmitted wave is transmitted from the transmitting antenna, and the reflected wave reflected by the object is received by multiple receiving antennas. The radar sensor 130 AD converts the signal of the reflected wave received by the plurality of receiving antennas to generate radar received data. The radar sensor 130 stores the generated radar received data in the ROM/RAM 140 via I/F 131.

The DSP 120a (for example, the first signal processing unit) and the DSP 120b (for example, the second signal processing unit) perform predetermined digital signal processing on the radar received data received by the radar sensor 130. The DSPs 120a and 120b obtain radar received data stored in the ROM/RAM 140, perform digital signal-processing on the obtained radar received data, and store the processed data in the ROM/RAM 140. The DSPs 120a and 120b execute the distributed process in response to control from the CPU 110.

The CPU 110 is a control unit for controlling the operation of each part of the semiconductor device 100. For example, the function of the CPU 110 is realized by executing a program stored in the ROM/RAM 140. The CPU 110 controls the distribution of processes (process content and throughput) performed by the DSPs 120a and 120b. The CPU 110 may execute the software processing and store the processing result in the ROM/RAM 140 as required for the processing result of DSPs 120a and 120b stored in the ROM/RAM 140.

In FIG. 5, it shows the case of two DSPs, it is possible to apply the embodiment in the same manner even in the case of three or more plurality of DSPs. Further, not only DSP but also in the case of performing a software process such as a hardware accelerator or a CPU of a plurality of cores, the present embodiment can be applied in the same manner.

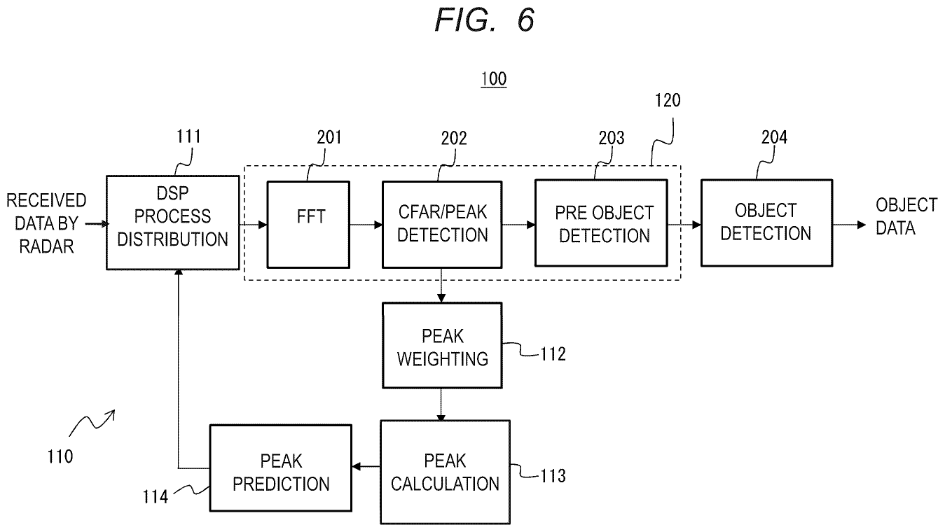

FIG. 6 shows an example of configuration of a functional block of the semiconductor device 100 (CPU and DSP) of FIG. 5. As shown in FIG. 6, a semiconductor device 100 includes, as functional blocks, an FFT unit 201, a CFAR/peak detection unit 202, a preprocess unit of object detection (PRE OBJECT DETECTION) 203, and an object detection unit 204. The semiconductor device 100 further includes a DSP process distribution unit 111, a peak weighting unit 112, a peak detection number increase/decrease calculation unit (PEAK CALCULATION) 113, and a peak detection number prediction unit (PEAK DETECTION) 114.

In this embodiment, the FFT unit 201, the CFAR/peak detection unit 202, and the preprocess unit of object detection 203 are included in DSPs 120a and 120b. In addition, another unit, that is, the object detection unit 204, the DSP process distribution unit 111, the peak weighting unit 112, the peak detection number increase/decrease calculation unit 113, and the peak detection number prediction unit 114 are included in the CPU 110.

An FFT unit 201, a CFAR/peak detection unit 202, a preprocess unit of object detection (PRE OBJECT DETECTION) 203, and the object detection unit 204 are functional blocks similar to those of FIG. 1. That is, the FFT process unit 201 performs a FFT process on the radar received by the radar sensor 130. The FFT process unit 201 obtains the radar received data of one frame and performs Fourier transforms in the range direction and the Doppler direction on the obtained radar received data to generate an RD map. The FFT process can be performed by dividing it into several DSPs. For example, the FFT units 201 of DSPs 120a and 120b distributes the process amount (for example, the range) of FFT processing from the DSP process distribution unit 111 and performs FFT processing on the data of the distributed amount.

The CFAR/peak detection unit 202 performs CFAR/peak detection process on FFT map generated by the map unit 201. The CFAR/peak detection unit 202 uses CFAR process to detect the peak (peak point) of the signal level in the RD map of one frame. The CFAR/peak detection process is performed following FFT process. The CFAR/peak detection process cannot be performed by dividing it into a plurality of DSP. For example, either the CFAR/peak detection unit 202 in DSP 120a or the CFAR/peak detection unit 202 in DSP 120b is distributed from the DSP process distribution unit 111 to perform CFAR/peak detection process and executes CFAR/peak detection process according to the distribution.

The preprocess unit of object detection 203 performs preprocess of object detection required before the object detection process. The preprocess unit of object detection 203 may perform, for example, calculation processing (processing for determining the direction of the peak) for performing angle estimation as object detection pre-process. The object detection process can be executed at any timing before the object detection process. For example, object-detection pre-process may be performed following FFT process. The object-detection pre-process cannot be executed by dividing into two or more DSP. For example, one of the preprocess units of object detection 203 of DSPs 120a and 120b is distributed from the DSP process distribution unit 111 to perform preprocess of object detection, and performs preprocess of object detection according to the distribution.

The object detection unit 204 performs object detection process on the basis of the peak in one frame (RD map) detected by the CFAR/peak detection unit 202. The object detection process is performed after CFAR/peak detection process and the object detection pre-process. The object detection unit 204 outputs the object data of the detected object. For example, the object detecting process unit 204 stores object data in the ROM/RAM 140.

The peak weighting unit 112 performs weighting on the peak in one frame (RD map) detected by the CFAR/peak detection unit 202. The peak weighting unit 112 determines a weight coefficient according to the moving speed of the peak and multiplies the determined weight coefficient to the peak. The moving speed of the peak can be extracted from the radar received data of one frame. For example, based on the phase difference of the reflected waves received by the plurality of receiving antennas, it is possible to extract the moving speed of the peak.

The peak detection number increase/decrease calculation unit 113, from the peak detection number and the peak detection number in the past plurality of frames in the current frame, calculates the increase/decrease rate of the peak detection number. The increase/decrease ratio is a ratio in which the number of detection peaks of the next frame increases or decreases with respect to the number of detected peaks of the previous frame. The peak detection number increase/decrease calculation unit 113 counts the peak detection number in the frame using the detection number weighted by the peak weighting unit 112. The peak detection number increase/decrease calculation unit 113 is also a detection unit for detecting the process amount of CFAR/peak detection process (the number of peaks). The detected number of peaks detected by CFAR/peak detection unit 202 may be used as it is to calculate the increase/decrease rate.

The peak detection number predicting unit 114, based on the increase/decrease rate of the peak detection number calculated by the peak detection number increase/decrease calculation unit 113, predicts the peak detection number in the next frame. For example, since it is possible to grasp the increase and decrease tendency of the peak detection number from the increase and decrease rate of the peak detection number between frames, to predict the peak detection number of the next frame based on the increase and decrease tendency.

The DSP process distribution unit 111 distributes DSP process of the next frame based on the peak detection number of the next frame predicted by the peak detection number predicting unit 114. For example, the DSP process distribution unit 111 determines the distribution ratio of DSPs 120a and 120b according to the predicted number of peak detection FFT process, according to the distribution ratio, distributes the throughput of FFT process to DSPs 120a and 120b. Distribution rate is the ratio of the throughput to be distributed to DSPs 120a and 120b, respectively. The DSP process distribution unit 111 distributes CFAR/peak detection process and the object detection pre-process to one of DSPs 120a and 120b, respectively. One of the DSPs 120a and 120b distributes CFAR/peak detection process and the other of DSPs 120a and 120b distributes the object detection pre-process. The distribution of CFAR/peak detection process and the object detection pre-process may be set in advance.

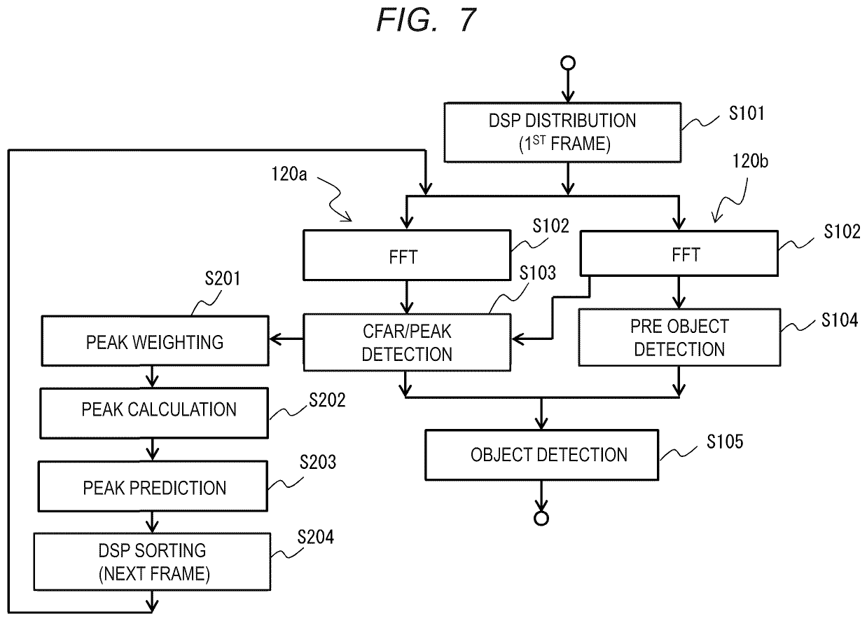

FIG. 7 shows an operation example of the semiconductor device 100 according to this embodiment. As shown in FIG. 7, first of all, the DSP process distribution unit 111 distributes the process of the first frame to the respective DSP (in step S101). The DSP process distribution unit 111 evenly distributes FFT process to the DSPs 120a and 120b. For example, the DSP process distribution unit 111 distributes FFT processing of the range of 50% of the radar received data of one frame to the DSP 120a, and distributes FFT processing of the range of the remaining 50% of the radar received data of one frame to the DSP 120b. The DSP process distribution unit 111 distributes CFAR/peak detection process to the DSP 120a and distributes the object-detection pre-process to the DSP 120b, for example.

Subsequently, FFT unit 201 of the DSPs 120a and 120b performs a FFT process on the radar received data of one frame (for example, the first frame) to be inputted (in step S102). The FFT unit 201 of DSPs 120a and 120b performs a FFT process on the radar received data of the range distributed from DSP process distribution unit 111 and generates a RD map of the corresponding range.

Subsequently, one CFAR/peak detection unit 202 of the DSPs 120a and 120b performs CFAR/peak detection process (in step S103). For example, the CFAR/peak detection unit 202 in the DSP 120a performs CFAR/peak detection process on DSPs 120a and 120b's FFT unit 201 generated RD map to detect the peak of one frame. That is, the CFAR/peak detection unit 202 in the DSP 120a performs DSP 120a peak detection process on FFT map generated by FFT unit 201 of DSP 120b when RD unit 201 of DSP 120a ends, FFT unit 201 performs CFAR/peak detection process on the generated RD map, and when DSP 120b's FFT unit 201 ends.

The other preprocess unit of object detection 203 of the DSPs 120a and 120b performs preprocess of object detection (in step S104). For example, the preprocess unit of object detection 203 of the DSP 120b executes object detection pre-process after FFT process of the DSP 120b.

When all processes in the DSPs 120a and 120b are completed in steps S102 to S104, DSP process for one frame is completed. Subsequently, the object detection unit 204 performs object detection process on the basis of the peak detection result of one frame (in step S105). For example, the object detection unit 204 executes the object detection process after CFAR/peak detection process and DSP 120b object detection pre-process by CFAR/peak detection unit 202 of DSP 120a to detect the object in one frame.

In addition, the peak weighting unit 112 performs the weighting to the peak detection from one frame following CFAR/peak detection process of one of the DSPs 120a and 120b (in step S201). For example, the peak of one frame detection by CFAR/peak detection unit 202 of DSP 120a is multiplied by a weight factor corresponding to the moving velocity of the peak. The peak weighting unit 112 extracts the moving speed of the peak from the radar received data of one frame and determines the weighting coefficient of the peak according to the extracted moving speed. The determined weight coefficient multiplied by the peak is counted as the number of detection points.

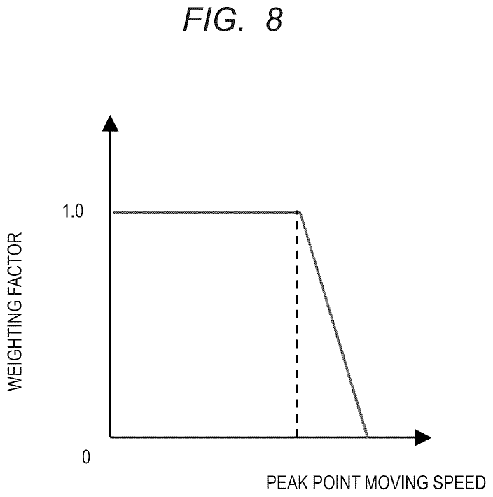

FIG. 8 is a graph showing an example of a weight coefficient determination table. For example, the peak weighting unit 112 derives a weighting coefficient according to the moving speed of the peak using a table in which the horizontal axis is the moving speed of the peak and the vertical axis is the weighting coefficient, as shown in FIG. 8. Using a table as shown in FIG. 8, to reduce the weight coefficient when the moving speed of the peak is fast, by increasing the weight coefficient when the moving speed of the peak is slow, to reduce the influence of the high point of the moving speed. If the moving speed of the peak is fast by counting with a small weight factor, it is possible to increase the accuracy of the prediction of the peak detection number. For example, it can be said that the weight factor indicates the confidence level of the detected peak.

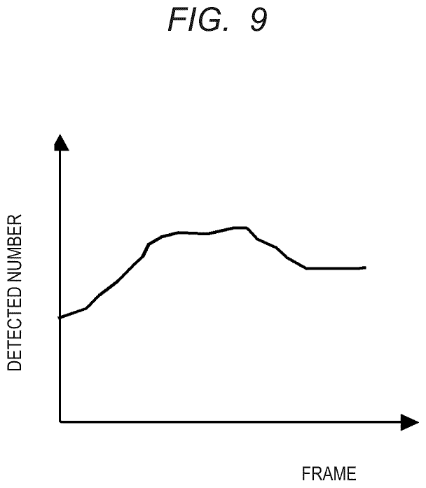

Subsequently, the peak detection number increase/decrease calculation unit 113 computes the increase/decrease rate of the peak detection number based on the value of the weighted peak in the plurality of frames (in step S202). FIG. 9 shows an example of the peak detection number in a plurality of frames. As shown in FIG. 9, the peak detection number increase/decrease calculation unit 113 counts the detected number of peaks weighted by the peak weighting unit 112 and stores the detected number in the ROM/RAM 140 as the counting result in the frame. The peak detection number increase/decrease calculation unit 113 calculates an increase/decrease rate of the peak detection number from the peak detection number in the present frame and the peak detection number in the past plurality of frames stored in the ROM/RAM 140.

Subsequently, the peak detection number predicting unit 114, based on the increase/decrease rate of the calculated peak detection number, predicts the peak detection number in the subsequent frame (in step S203). For example, the peak detection number prediction unit 114, based on the increase/decrease rate of the peak detection number determined from the current and past counting results, to predict an increase/decrease rate of the peak detection number in the next frame. For the prediction of the increase/decrease ratio, it is possible to simply use the difference from the previous frame or the average of the difference of the multiple frames, etc. The peak detection number predicting unit 114 predicts the peak detection number in the next frame in accordance with the predicted increase/decrease rate.

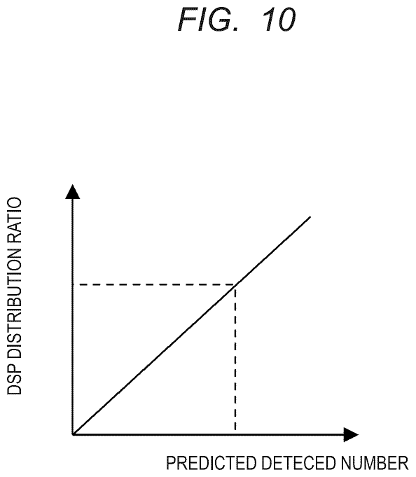

Subsequently, the DSP process distribution unit 111 distributes DSP process of the next frame on the basis of the predicted number of detection peaks of the next frame (S204). FIG. 10 is a graph illustrating an example of DSP distribution rate determination table. The DSP process distribution unit 111, as shown in FIG. 10, the horizontal axis of the predicted peak detection number, using a conversion table and a mathematical expression using DSP distribution ratio as a vertical axis, the peak detection number to convert DSP distribution ratio. The DSP distribution rate shows the rate at which FFT treatment is distributed to DSPs 120a and 120b. For example, the number of peak detection (process amount of DSP 120a) increases the ratio of the process to be distributed to DSP 120b is increased, the ratio of the process to be distributed to DSP 120a is reduced.

Conversely, when the number of detected peaks (the process amount of DSP 120a) is reduced, the ratio of distribution the process to DSP 120a is increased, the ratio of the process to be distributed to DSP 120b is reduced. Although the predicted peak detection number in FIG. 10 as the horizontal axis, the increase/decrease rate of the predicted peak detection number may be the horizontal axis. The DSP process distribution unit 111 performs distribution of DSP process (FFT process) of the following frame according to the converted DSP distribution rate. The DSPs 120a and 120b are executed after S102 according to the distribution. For example, as shown in FIG. 4A and FIG. 4B, when assigning the arithmetic process amount of the process A (FFT process) at a rate of 50:50 for DSPs 120a and 120b as an initial-state, the arithmetic process amount distributed to each of DSPs 120a and 120b in accordance with the distribution rate It is processed in each DSP.

As described above, in the present embodiment, in the semiconductor device that performs radar signal processing, the distribution of DSP processing is performed based on the number of detected peaks in the past. Specifically, to predict the peak detection number of the next frame based on the increase/decrease rate of the number od detected peaks in a plurality of frames in the past, to determine the distribution of processing according to the predicted peak detection number. This improves the efficient use of DSP and shortens the overall process times. Since the number of detected peaks is predicted using the information of the past multiple frames, it is possible to improve the prediction accuracy by eliminating the noise-like effect that protrudes by one frame.

### Modification of the First Embodiment

In a modification of the first embodiment, DSP process is distributed based on the process times of CFAR/peak detection process.

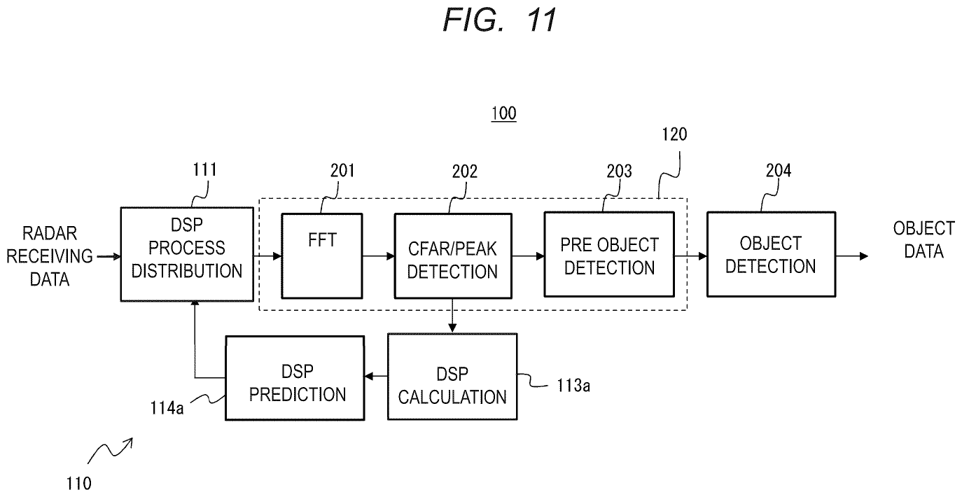

FIG. 11 shows a configuration example of a functional block of the semiconductor device 100 according to a modification of the first embodiment. In FIG. 11, the semiconductor device 100 includes a DSP process time increase/decrease calculation unit 113a, DSP process time prediction unit 114a, instead of the peak weighting unit 112, the number of detected peaks decreases calculation unit 113, and the number of detected peaks prediction unit 114, as compared with FIG. 6.

The DSP process time increase/decrease calculation unit 113a calculates an increase/decrease rate of the process time of the DSP 120. For example, DSP process time increase/decrease calculation unit 113a measures the process time of CFAR/peak detection process of one frame executed by CFAR/peak detection unit 202 of one of DSPs 120a and 120b. The DSP process time increase/decrease calculation unit 113a is also a detection unit time) of CFAR/peak-for detecting the throughput (process detection process. The DSP process time increase/decrease calculation unit 113a calculates an increase/decrease rate of the process time of CFAR/peak detection process of one frame from the process time of CFAR/peak detection process of the current one frame of CFAR/peak detection unit 202 and the process time of CFAR/peak detection process of the previous plural frames.

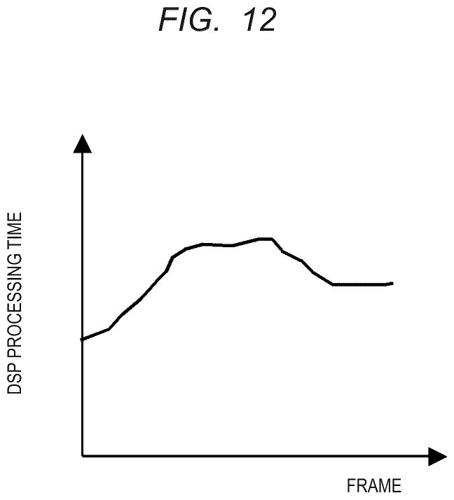

FIG. 12 shows an exemplary DSP process times in a plurality of frames. The DSP process time increase/decrease calculation unit 113a, as shown in FIG. 12, measures the process time of CFAR/peak detection process (DSP process time) for one frame executed by CFAR/peak detection unit 202 and stores it in the ROM/RAM 140 as a measured result in the frame. DSP process time increase/decrease calculation unit 113a calculates an increase/decrease rate of the process time of CFAR/peak detection process from the process time of CFAR/peak detection process in the present frame and the process time of CFAR/peak detection process in the previous plural frames stored in the ROM/RAM 140.

The DSP process time predicting unit 114a predicts the process time of the subsequent frame based on the increase/decrease rate of the process time of one frame calculated by DSP process time increase/decrease calculation unit 113a. For example, the DSP process time predicting unit 114a predicts the increase/decrease rate and the process time of CFAR/peak detection process in the subsequent frame based on the increase/decrease rate of CFAR/peak detection process obtained from the process time of the present and the previous peak detection process.

The DSP process distribution unit 111 distributes DSP process of the next frame based on the process time of the next frame predicted by DSP process time predicting unit 114a. The distribution method of the processing is the same as that of the first embodiment. For example, DSP process distribution unit 111 determines the distribution ratio of CFAR/peak process to be performed by DSPs 120a and 120b according to the predicted process times of the peak detection process, and distributes FFT process to DSPs 120a and 120b according to the determined distribution ratio.

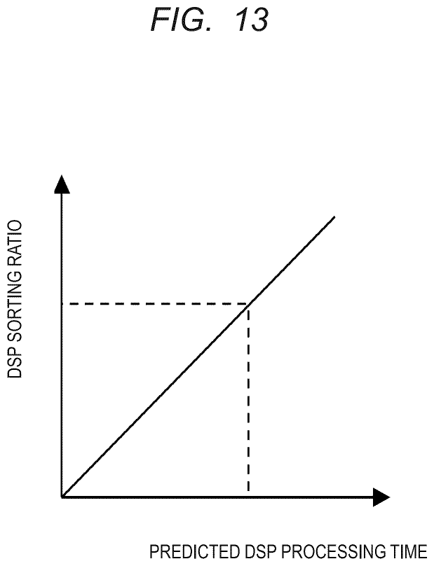

FIG. 13 is a graph illustrating an exemplary DSP distribution rate determination table. The DSP process distribution unit 111, as shown in FIG. 13, converts the process time of CFAR/peak detection process (DSP process time) into a DSP distribution rate using a conversion table or a mathematical expression in which the horizontal axis represents the process time of the predicted CFAR/peak detection process and the vertical axis represents DSP distribution rate.

As described above, instead of the detected number of peaks, the process time of each DSP is measured to calculate the increase/decrease rate of DSP process time of each frame, DSP process distribution rate from the increase/decrease rate of the process time it may be determined. In this case, without counting the number of detected peaks, grasp the bias of each DSP process, it is possible to appropriately distribute each DSP process.

### Second Embodiment

Next, the second embodiment will be described. In this embodiment, an example of correcting the prediction result of the number of detected peaks will be described based on the tracking result of the object.

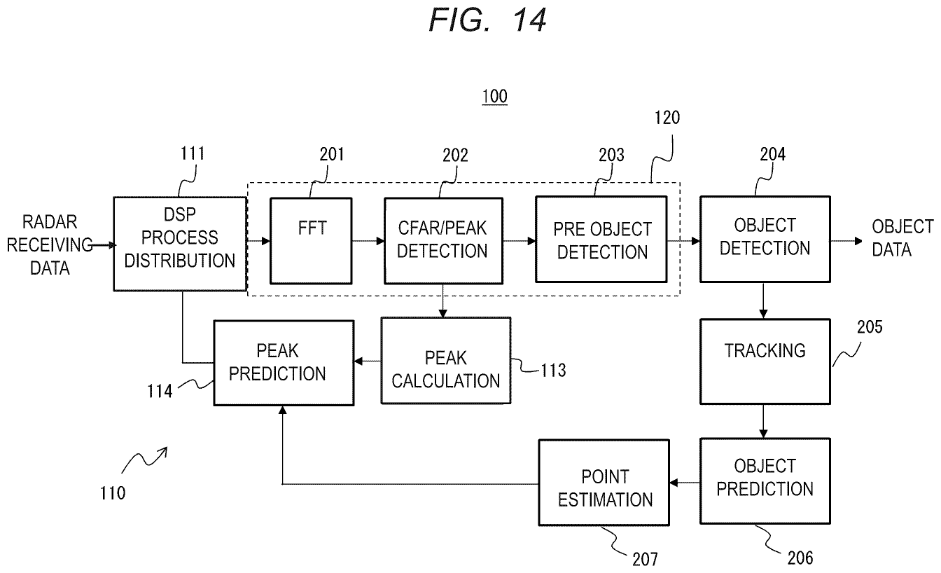

FIG. 14 shows a configuration example of a functional block of the semiconductor device 100 according to this embodiment. In the example of FIG. 14, in addition to the configuration of FIG. 6, the semiconductor device 100 includes a tracking unit 205, an object disappearance prediction unit 206, and a point group number estimation unit 207. In FIG. 14, the peak weighting unit 112 is omitted, but may be provided with a peak weighting unit 112 in the same manner as in FIG. 6.

In the object detection process of the object detection unit 204, a plurality of points (point clouds) having the close position, the same movement direction, and the same movement speed are treated as the same object. At this time, the number of points is stored in the ROM/RAM 140 as the same object.

The tracking unit 205 is similar to the tracking unit of FIG. 1. That is, the tracking unit 205 performs tracking processing on the basis of the object detected by the object detection unit 204. The tracking unit 205 tracks the object based on the object detection result of a plurality of frames. For example, the object detection result of each frame is stored in the ROM/RAM 140, and in the tracking process, the object specified as the same object is tracked from the position, movement direction, and movement speed of the object detected in the current frame and the object in the past frame.

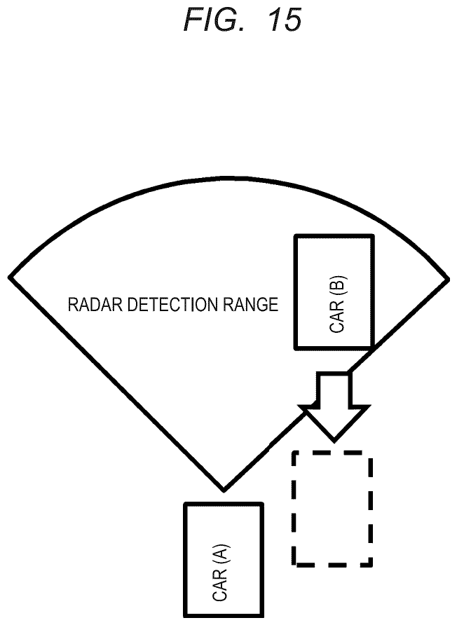

The object disappearance prediction unit 206 predicts an object which is out of the detection range of the radar (disappears) in the next frame from the movement direction and the movement speed of the object tracked by the tracking unit 205. For example, when the radar sensor 130 is a vehicle-mounted radar, it is predicted that the detected object will frame out (disappear) from the detection range of the radar by the difference between the own vehicle and the oncoming vehicle as shown in FIG. 15.

The point cloud number estimation unit 207 estimates the number of point clouds (the number of peaks) corresponding to an object that is outside the detection range of the radar based on the prediction result of the object vanishing prediction unit 206. For example, when an object is detected, the data stored in the ROM/RAM 140 is used as the number of point clouds of the object to be lost.

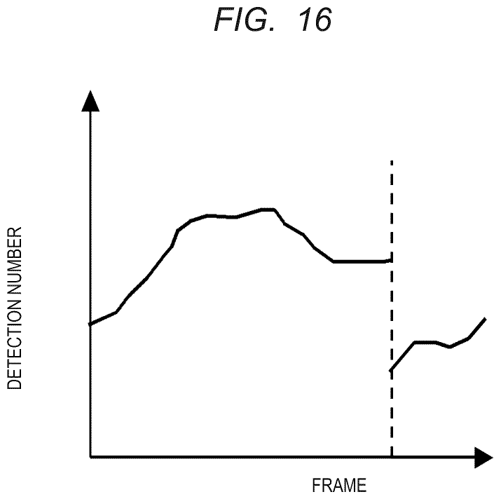

The peak detection number predicting unit 114, based on the increase/decrease rate of the peak detection number calculated by the number of detected peaks increase/decrease calculation unit 113, when predicting the number of detected peaks in the next frame, the number of point groups estimated by the point group number estimation unit 207 from the predicted detection number subtracts the number of vanishing. That is, the number of detected peaks prediction unit 114, based on the tracking result, corrects the predicted number of detected peaks. For example, as shown in FIG. 16, from the detected number predicted based on the number of detected peaks in a plurality of frames, a value obtained by subtracting the number of point groups to disappear and the peak detection number of the next frame.

As in the first embodiment, DSP process distribution unit 111 calculates DSP distribution ratio from the number of detected peaks of the next frame based on the value obtained by subtracting the number of point groups to be disappeared and performs distribution of DSP process of the next frame by the calculated distribution ratio.

For example, in the first embodiment, it is impossible to follow up when the number of detection points changes suddenly, such as when the detected object becomes invisible by framing out, such as when the vehicle moves away as shown in FIG. 15. In the present embodiment, an object is detected from the detected point group, and from the tracking processing result that follows the movement of the object, it is predicted (loss detection) that the object becomes invisible in the next frame, and the number of detected points in the next frame is predicted by estimating the number of point group to be lost. Thus, it is possible to increase the accuracy of the prediction of the number of detected peaks.

### Third Embodiment

Next, a description will be given embodiment 3. In this embodiment, an example of learning and predicting the number of detected peaks using a learning model will be described.

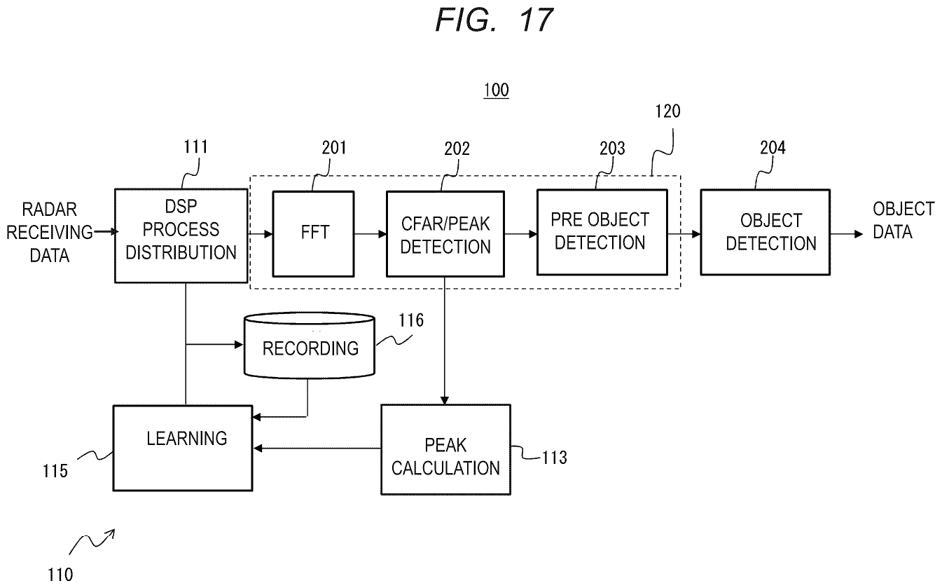

FIG. 17 shows a configuration example of a functional block of the semiconductor device 100 according to this embodiment. In the example of FIG. 17, compared with the configuration of FIG. 6, the semiconductor device 100 includes a time series prediction learning unit (LEARNING) 115 and a predicted detection number recording unit (RECORDING) 116, instead of the number of detected peaks prediction section 114. In FIG. 17, although the peak weighting unit 112 is omitted, the peak weighting unit 112 may be provided similarly to FIG. 6.

The predicted detection number recording unit 116 records (stores) the detection number predicted by the time series prediction learning unit 115. The predicted detection number recording unit 116 may be included in the ROM/RAM 140.

The time series prediction learning unit 115 learns the time series prediction, obtains a predicted value of the number of detected peaks. The time series prediction learning unit 115 learns and predicts the number of detected peaks in the next frame on the basis of the increase/decrease rate of the number of detected peaks obtained by the number of detected peaks increase/decrease calculation unit 113. The time series prediction learning unit 115 learns the predicted value of the number of detected peaks while recording the number of detected peaks predicted in the past in the predicted detection number recording unit 116.

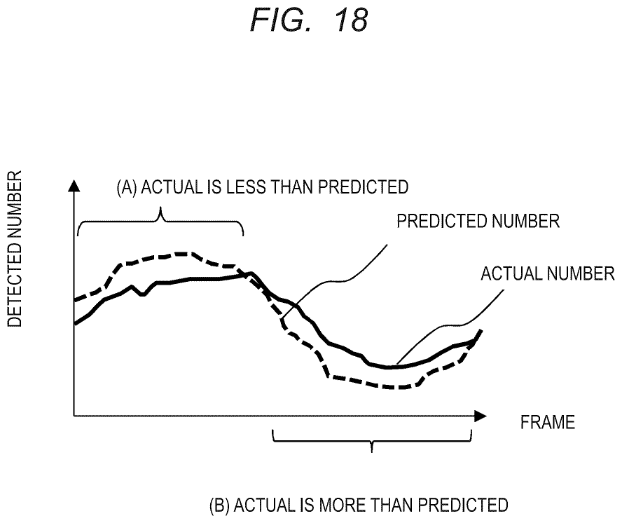

For example, as shown in FIG. 18, a difference between the actual number of detected peaks and the number of detected peaks predicted in the past and a tendency of the difference are learned by time series prediction, and the predicted value is corrected at any time to reduce the prediction error of the subsequent frames. An autoregressive model (AR model), a moving average model (MA model), or the like can be applied to the time series prediction of the time series prediction learning unit 115.

As in the first embodiment, DSP process distribution unit 111 calculates DSP distribution ratio from the predicted number of detected peaks of the next frame and performs distribution of DSP process of the next frame by the calculated distribution ratio.

In the first embodiment, when the prediction of the number of detected peaks is wrong, it will take more process time than assumed. In the present embodiment, by using the time series prediction and by correcting the prediction error of the number of detected peaks at any time, it is possible to reduce the amount of prediction deviates.

Incidentally, the present embodiment may be applied to a modification of the first embodiment and the second embodiment. For example, in the modification of the first embodiment, DSP process times may be learned and predicted as in the present embodiment. When DSP process time is learned, the process time of CFAR/peak detection process may be learned, or the free time of DSP process may be learned. By learning and predicting the difference between the time when CFAR/peak detection process ends and the time when the object-detection pre-process ends, DSP process can be distributed so that the difference becomes small.

### Modification of the Third Embodiment

As a modification of the third embodiment, the table for deriving DSP distribution ratio from the predicted number of detected peaks may be modified at any time.

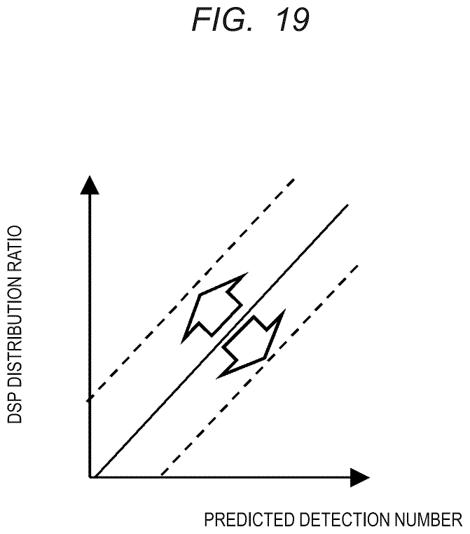

FIG. 19 shows an example of a DSP distribution rate determination table according to a modification of the third embodiment. As shown in FIG. 19, it may be shifted upward or downward the table and equation for calculating DSP distribution ratio from the predicted number of detected peaks on the graph. The vertical direction of the graph is a vertical axis direction indicating DSP distribution ratio. By shifting the table and the mathematical expression in the vertical direction, it is possible to change the distribution ratio to the predicted number of detected peaks. For example, the time series prediction learning unit 115 or the DSP process distribution unit 111 may learn to obtain the optimum DSP distribution rate while shifting the table or the equation for calculating DSP distribution rate.

Thus, even in the configuration of correcting at any time the table for deriving DSP distribution ratio from the predicted number of detected peaks, the same advantages as the third embodiment can be obtained.

It should be noted that the respective components described and described in the drawings as functional blocks for performing various processes may be configured in terms of hardware, CPU, memory, or other circuitry, and in terms of software, may be implemented in programs loaded into the memory, or the like. Therefore, it is understood by those skilled in the art that these functional blocks can be realized in various forms by hardware alone, software alone, or a combination thereof, and the present invention is not limited to any of them.

The programs are stored using various types of non-temporary computer readable media (non-transitory computer readable medium) and can be supplied to a computer. Non-transitory computer readable media includes various types of tangible storage media. Examples of non-transitory computer-readable media include magnetic recording media (e.g., flexible disks, magnetic tapes, hard disk drives), magneto-optical recording media (e.g., magneto-optical disks), CD-ROM (Read Only Memory, a CD-R, a CD-R/W, solid-state memories (e.g., masked ROM, PROM (Programmable ROM), EPROM (Erasable PROM, flash ROM, RAM (Random Access Memory)). The programs may also be supplied to the computer by various types of transitory computer-readable transitory computer readable media. Examples of transitory computer-readable media include electrical signals, optical signals, and electromagnetic waves. The transitory computer readable medium may provide the program to the computer via wired or wireless communication paths, such as electrical wires and optical fibers.

Although the invention made by the inventor has been specifically described based on the embodiment, the present invention is not limited to the embodiment already described, and it is needless to say that various modifications can be made without departing from the gist thereof.

What is claimed is:

1. A semiconductor device comprising:
a first signal processing unit, a second signal processing unit, and a control unit,
wherein the first signal processing unit and the second signal processing unit perform a first process and a second process performed on the basis of the result of the first process,
wherein the control unit comprises:
a detection unit for detecting a process amount of the second process performed by the first signal processing unit or the second signal processing unit;
a prediction unit for predicting the process amount of the second process to be performed next based on the process amount of the detected second process; and
a distribution unit for distributing the first process to the first signal processing unit and the second signal processing unit based on the process amount of the predicted second process.

2. The semiconductor device according to claim 1,
the distribution unit distributes the second process to the first signal processing unit or the second signal processing unit.

3. The semiconductor device according to claim 2,
the first signal processing unit and the second signal processing unit perform a third process,
the distribution unit distributes the second process to one of the first signal processing unit and the second signal processing unit, and distributes the third process to the other of the first signal processing unit and the second signal processing unit.

4. The semiconductor device according to claim 1 further comprising a storage unit for storing the process amount of the detected second process,
wherein the prediction unit predicts the process amount of the second process to be performed next based on the process amount of the second process and the process amount of the detected second process and the process amount of the stored second process in the past.

5. The semiconductor device according to claim 1,
wherein the distribution unit determines a distribution ratio of the first process to the first signal processing unit and the second signal processing unit based on the process amount of the predicted second process.

6. The semiconductor device according to claim 1,
wherein the process amount of the second process is process time of the second process.

7. The semiconductor device according to claim 1,
wherein the first process is a FFT process for received data of the radar, the second process is a peak detection process for result of the FFT process, and the process amount of the second process is a number of detected peaks detected by the peak detection process.

8. The semiconductor device according to claim 7,
wherein the detection unit performs a weighting process based on a moving speed of peaks with respect to the peaks detected by the peak detection process.

9. The semiconductor device according to claim 7 further comprising an object detection unit for detecting an object based on the peak detected by the peak detection process, and a tracking unit for tracking the detected object,
wherein the prediction unit corrects the detected number of the predicted peak based on the result of the tracking.

10. The semiconductor device according to claim 9,
when the detected object is predicted to disappear from the detection range of the radar in the result of the tracking, the prediction unit subtracts the number of peaks corresponding to the disappeared object from the detected number of peaks.

11. The semiconductor device according to claim 1,
wherein the prediction unit includes a learning model in which the process amount of the second process to be performed next is learned based on the process amount of the detected second process.

12. The semiconductor device according to claim 11 further comprising a storage unit for storing the process amount of the second process in which the learning model is predicted,
wherein the learning model performs the learning based on the process amount of the detected second process and the process amount of the stored second process in the past.

13. A controlling method for the semiconductor device according to claim 1, the controlling method comprising the steps of:
detecting the process amount of the second process based on the process amount of the detected second process;
predicting the process amount of the second process to be performed next based on the process amount of the predicted second process; and
distributing the first process to the first signal processing unit and the second signal processing unit.

14. A program comprising program instructions for causing a computer to perform the controlling method according to claim 13.
